(19) United States
(12) Patent Application Publication
(10) Pub. No.: US 2016/0156639 A1
(43) Pub. Date: Jun. 2, 2016

(54) METHOD FOR EXCHANGING DATA AND ELECTRONIC DEVICE FOR THE SAME

(71) Applicants: Inventec (Pudong) Technology Corporation, Shanghai (CN); INVENTEC CORPORATION, Taipei City (TW)

(72) Inventor: Sheng-Hsin LO, Taipei City (TW)

(21) Appl. No.: 14/677,412

(22) Filed: Apr. 2, 2015

(30) Foreign Application Priority Data
Nov. 27, 2014 (CN) 201410710588.X

(51) Int. Cl. H04L 29/06; H04L 12/26; G06F 17/30; H04L 29/08

(52) U.S. Cl. CPC H04L 63/123; H04L 67/06; H04L 43/04; G06F 17/30864

(57) ABSTRACT

A technique for exchanging data is carried out when an electronic device is operated to execute the method including the following steps. Firstly, a data capturing module of the electronic device is operated to capture a communication data, and a data analysis module of the electronic device automatically analyzes the communication data to obtain at least one communication feature data. Next, a verifying module of the electronic device automatically captures at least one comparison communication data to compare the communication feature data with the comparison communication data so as to accordingly generate a verifying result. Finally, the verifying result is displayed on a display module of the electronic device for a user to read immediately.

### BACKGROUND OF INVENTION

1. Field of the Invention

The invention relates to an electronic device and an accompanying method for exchanging data, and more particularly to the electronic device for exchanging data and the method for the same that can verify automatically the exchange data so as to immediately complete the data exchanging and so as further to allow the user of a mobile electronic communication apparatus equipped with the device to look up a verifying result generated from verifying a communication data in a real time manner.

2. Description of the Prior Art

With the blooming progress in computer and information industry, people can use a mobile electronic communication apparatus to get more and more information from various sources. However, under such a circumstance, reliability of the information is highly questioned. Therefore, for the sake of people in this huge information sea, screening and verifying upon the data/information become extremely significant.

In particular, various scams grow with the technology progress especially in communication field. The major reason that people is “successfully” cheated is because of lack of auxiliary sources to help verifying immediately the credibility and reliability of the information at hand. Hence, under such a harsh environment for verifying in a real-time manner the events people face, people is usually vulnerable to be hurt by some illegal or scam groups.

In addition, as the information industry blooms, more and more communication means are available for people. Besides the conventional face-to-face talking, styles for people-to-people communications can further include the telephone communication, the email communication, the online video communication, and other communication styles through advanced technology. Plenty of communications through various means has made people's life versatile. However, it is also possible that, in human's limited memory, some of those communications may be forgotten forever, totally or partly. Definitely, it is hard for a single people to remember every talking, every message or every face in his/her life. Sadly, for some particular situations, loss memory might cause troubles or embarrassed atmosphere to people's social life. Politeness and respect feeling are problems during such an embarrassing interaction. Hence, particular methods or equipments would be important to people for getting back some particular events, such that possible embarrassed situations can be somehow avoided in people's social life.

For example, one of those embarrassed or less-polite scenes in business life would be a consequence of the following events listed typically in a time order: (1) the business representative of one of important clients A to Company B was new on board; (2)

Company B was then informed of this change by phone or email; (3) the new representative made an appointment to visit Company B by phoning or emailing the correspondent in Company B; (4) while the new representative attended Company B, the correspondent of Company B forgot the appointment, the purpose of this visit or even the position of the new representative; (5) the new representative fell embarrassed and also un-respected as soon as he/she was aware of this situation in Company B; and thus (6) a backward upon the relationship in between is definitely inevitable.

While in facing the aforesaid situations, it would be highly appreciated if there is a way to recover the historical communication records at the very first time. However, in the art, it is the usual case that the historical communication records can only be recovered by online searching or other investigation alternatives through some other persons such as the assistants. The demand of “to recover at the very first timing” is, actually, never and impossibly met. Therefore, the inventor of this disclosure aims at the demand of “to provide verified communication data automatically in a real time manner” to provide an improved technique for data exchange, and thereby a verifying result upon the exchanged data can be provided automatically to the user for his/her immediate looking up.

### SUMMARY OF THE INVENTION

Accordingly, it is the primary object of the present invention to provide a technique for exchanging data, which utilizes an electronic device to perform the following method. In this technique, a data capturing module of the electronic device is operated to capture a communication data, and a data analysis module of the electronic device automatically analyzes the communication data to obtain at least one communication feature data. Next, a verifying module of the electronic device automatically captures at least one comparison communication data to compare the communication feature data with the comparison communication data so as to accordingly generate a verifying result. Finally, the verifying result is displayed on a display module of the electronic device for a user to read immediately.

In the present invention, the electronic device includes a data capturing module, a data analysis module, a verifying module and a display module. The data capturing module is to capture the communication data. The data analysis module coupled with the data capturing module is to analyze the communication data to obtain at least one communication feature data. The verifying module coupled with the data analysis module is to capture at least one comparison communication data so as to automatically compare the communication feature data and the comparison communication data to generate accordingly a verifying result. The display module coupled with the verifying module is to display the verifying result.

In the present invention, the method for exchanging data to be performed at the aforesaid device includes the following steps. Firstly, the data capturing module is applied to capture the communication data. This step can introduce a non-contact means to capture the communication data, in which the non-contact means can be performed as any one of the following three operations or any other types of the non-contact means:

(a1) obtaining the communication data by capturing and analyzing an image of the communication data;

(a2) obtaining the communication data through a wireless transmission; and

(a3) obtaining the communication data by scanning and analyzing a barcode.

In the present invention, the communication data can include all the required data for communicating with the government, the juridical person, the natural person, non-corporate body or any other organization, and the communication feature data can include at least one of a name of government facilities, a company name, an ID number of a company, a website of a company, an address of a company, a name of a correspondence, a telephone number, an email address and any the like.

In addition, the comparison communication data can be at least one address book data stored in the electronic device or data searched from specific or unspecific websites by the network search means.

Preferably if the verifying result is that the communication feature data and the address book data are totally unmatched, then apply a network search means to search the communication feature data, thereby to generate a corresponding search result, and further to issue a first indication message for indicating the search result and inquiring a user of the electronic device whether or not to add the communication data into the address book data. Or, the network search means can be used to define the unmatched data quantity between the comparison communication data and the communication feature data so as to have the verifying result to include a reliability assessment of the communication data, in which the reliability assessment can be represented by a reliability assessment symbol. Further, the network search means can be applied to determine a public adverse-assessing quantity related to the communication feature data and further to generate an online public assessment, which can be symbolized by an online public assessment.

Preferably, the data capturing module of the electronic device can include one of an image analysis module, an NFC module and a barcode analysis program, or any application program related to the captured communication data.

In addition, the electronic device can further include an address book database and a network communicating module. The address book database stores at least one address book data for the verifying module capture to capture as one of the comparison communication data. The network communicating module is to perform the network search means.

By compared to the conventional technique, the data-exchange technique for at least one electronic device to perform uni-directional or bi-directional capturing of the communication data in accordance with the present invention can simultaneously provide both near-end verification upon the address book data in the electronic device and far-end verification through a relevant network search means to automatically obtain corresponding verifying result on the captured communication data. Thus, the user can utilize the verifying result in a real-time manner to evaluate the credibility and the communication records of the communication data. It is no doubt that, by providing the technique for exchanging data in accordance with the present invention including the electronic device and the associating method, the situations of the scam, in-politeness, and embarrassment can be reduced to a minimum.

All these objects are achieved by the electronic device and the accompanying method for exchanging data described below.

### BRIEF DESCRIPTION OF THE DRAWINGS

The present invention will now be specified with reference to its preferred embodiment illustrated in the drawings, in which:

FIG. 1 is a block diagram of the preferred electronic device for exchanging data in accordance with the present invention;

FIG. 2A and FIG. 2B show integrally a flowchart of a first embodiment of the method for exchanging data in accordance with the present invention, performable to the electronic device of FIG. 1;

FIG. 3 demonstrates typically a portion of the display window of the display module of FIG. 1;

FIG. 4 demonstrates typically another portion of the display window of the display module of FIG. 1;

FIG. 5 shows a flowchart of a second embodiment of the method for exchanging data in accordance with the present invention;

FIG. 6 demonstrates typically a portion of the display window of the display module of the second embodiment of FIG. 5; and

FIG. 7 demonstrates typically another portion of the display window of the display module of the second embodiment of FIG. 5.

### DESCRIPTION OF THE PREFERRED EMBODIMENT

The invention disclosed herein is directed to an electronic device for exchanging data and a method for the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

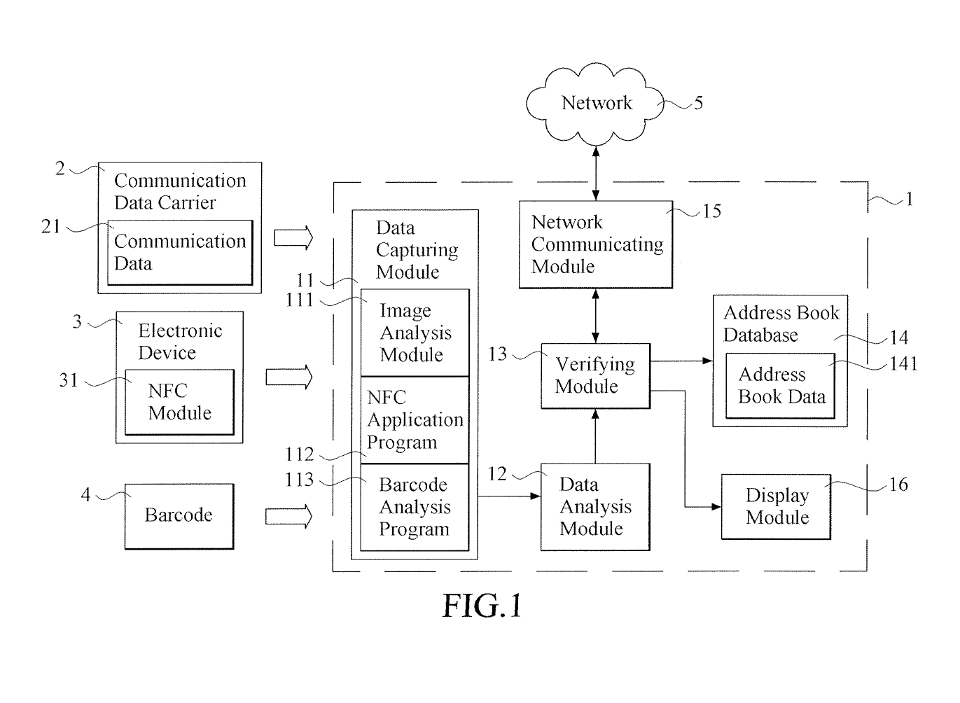

Referring now to FIG. 1, a block diagram of the preferred electronic device for exchanging data in accordance with the present invention is schematically shown in a block diagram. As shown, the electronic device 1 includes a data capturing module 11, a data analysis module 12, a verifying module 13, an address book database 14, a network communicating module 15 and a display module 16. The electronic device 1 can be a stationary or portable electronic device capable of communicative functions, such as a desktop computer, a notebook computer, a tablet computer, a mobile phone or any the like. The data capturing module 11 is built inside with an image analysis module 111, an NFC module 112 and a barcode analysis program 113. In addition, the built-in parts of the data capturing module 11 can also include the application programs related to the capturing of the communication data.

The data analysis module 12 coupled with the data capturing module 11 is to analyze the communication data and thereby generate at least one communication feature data. The verifying module 13 is coupled with the data analysis module 12, the address book database 14, the network communicating module 15 and the display module 16, and is thereby to automatically verify the communication data, in which the address book database 14 can store at least one address book data 141.

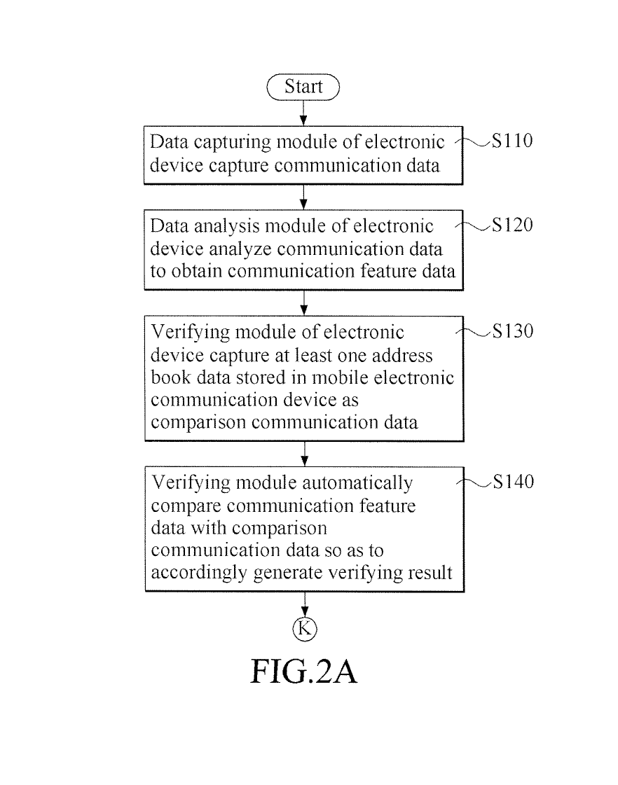

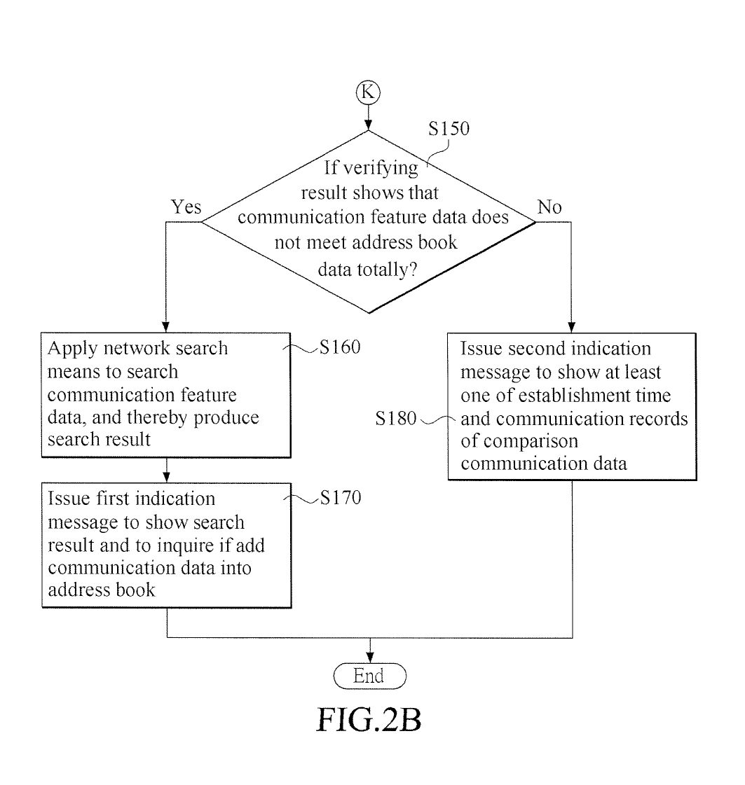

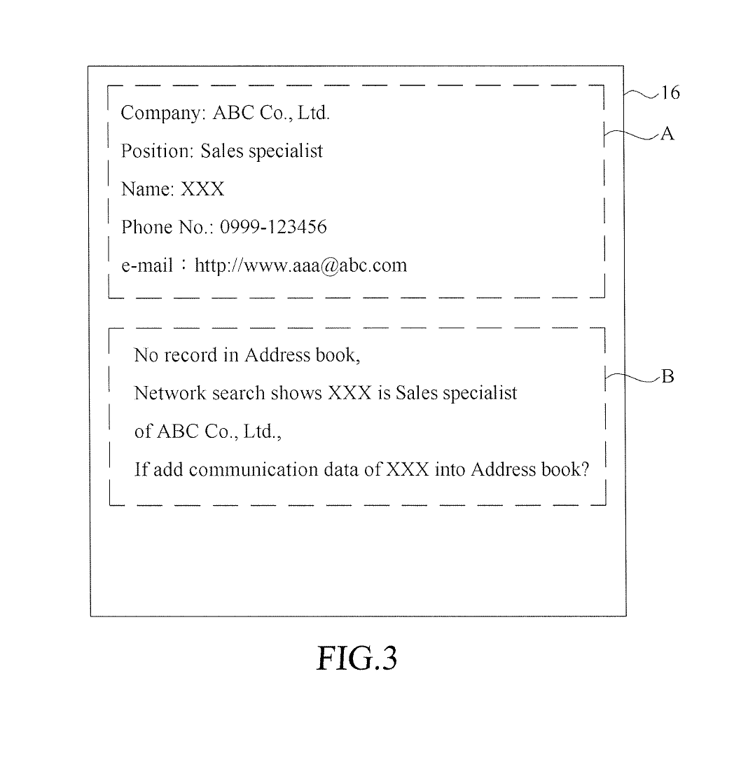

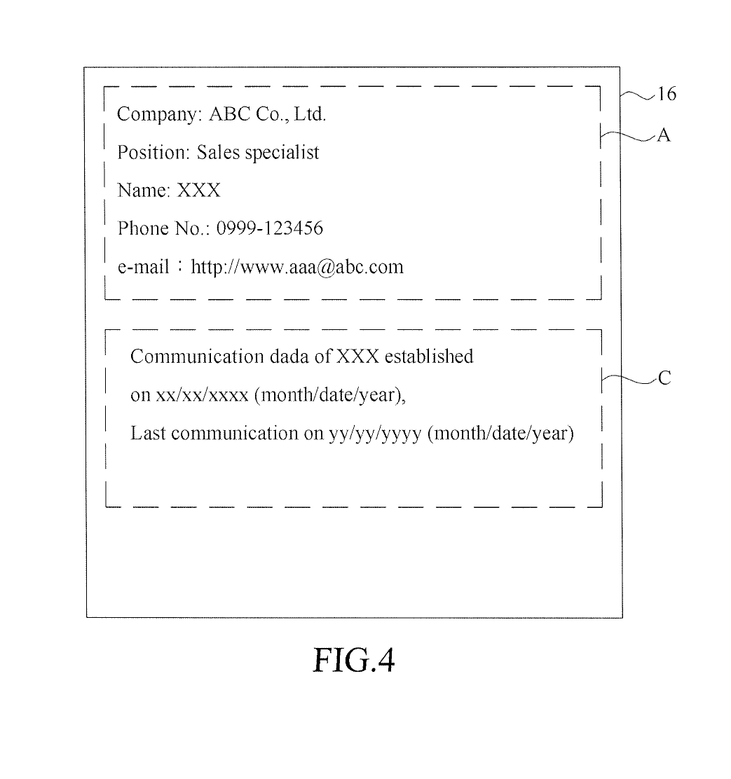

Refer now to FIG. 2A through FIG. 4, in which FIG. 2A and FIG. 2B show integrally a flowchart of a first embodiment of the method for exchanging data performable to the electronic device of FIG. 1 in accordance with the present invention, FIG. 3 demonstrates typically a portion of the display window of the display module of FIG. 1, and FIG. 4 demonstrates typically another portion of the display window of the display module of FIG. 1. In this first embodiment, the method to be performed on the electronic device for exchanging data in accordance with the present invention is mainly to execute the near-end verification upon the address book data and introduce a network search means to amend the near-end verification. The first embodiment of the method for the electronic device to perform data exchange includes the steps as follows.

Firstly, in step S110, the electronic device 1 is operated to have the data capturing module 11 to apply a non-contact means to capture a communication data so as to complete the data exchange. In this disclosure, the term “non-contact means” implies the maneuvering without finger touch to input the communication data or with a cable to transmit the communication data. Preferably, the non-contact means can have the following three pathways.

One of the three pathways is to capture the image of the communication data carrier 2 by photographing or the like so as to form a corresponding image of the communication data. The image analysis module 111 is further applied to analyze the communication data 21 recorded on the communication data carrier 2. In the present invention, the communication data carrier 2 can be a name card, a product packing, a catalogue or any solid carrier that includes communication data to be read. Preferably, the image analysis module 111 can be an optical character recognition (OCR) program.

Another one of the three pathways is to capture the communication data by wireless transmission, particularly by near field communication (NFC) such as the ultra red light, the Bluetooth, the Zwave, the ZigBeeor and the WiFi. For example, the electronic device 1 may include (but not limited to) an NFC module to capture the communication data stored in the electronic device 3.

The third one of the three pathways for capturing the communication data by utilizing a data capturing module 11 of the electronic device 1 to scan a barcode 4, and further introducing a barcode analysis program 113 to analyze the communication data related to the barcode, in which the barcode can be a 1-D barcode, 1 2-D barcode (QR Code, for example) or any type of barcode coded by proper coding format.

After the step S110 has been executed, the data analysis module 12 of the electronic device 1 would automatically analyze at least one communication feature data from the communication data (Step S120). It is noted that the aforesaid communication data can include all the required data for communicating with the government, the juridical person, the natural person, non-corporate body or any other organization. The aforesaid communication feature data analyzed from the communication data can be the name of the government facilities, the company name, the ID number of the company, the website of the company, the address of the company, the name of the correspondence, the telephone number, the email address, or any the like.

After the step S120 has been executed, the verifying module 13 of the electronic device 1 would automatically capture the address book data 141 of the address book database 14 stored in the electronic device 1 as a comparison communication data (Step S130). Then, the verifying module 13 of the electronic device 1 would automatically compare the communication feature data and the comparison communication data so as to generate a verifying result (Step S140). At this time, the verifying module 13 of the electronic device 1 would further automatically judge if the verifying result tells that the communication feature data and the address book data are totally un-matched (Step S150).

While the verifying result between the communication feature data and the address book data is totally un-matched, the verifying module 13 would apply the network communicating module 15 and a network search means to perform an online search upon the communication feature data so as to generate a search result (Step S160), and thereby further to issue a first indication message for indicating the search result and also inquiring the user of the electronic device 1 whether or not the communication data shall be added into the address book data 141 (Step S170). In the present invention, the so-called network search means is to make the verifying module 13 go through the network communicating module 15 to connect a network 5 so as to perform online search, through the network, upon the comparison communication data around some specific or unspecific websites, in which the network 5 can be an internet, a near-end local network or a far-end specialized network.

As shown in FIG. 3, after the Step S170 has been executed, the display module 16 of the electronic device 1 would automatically display the target to be verified (i.e. the aforesaid communication data and communication feature data) on a display window A, and also automatically displays the first indication message of Step 170 on another display window B.

Back to Step S150, as the verifying result shows that the communication feature data is matched with at least a portion of the address book data, the verifying module 13 would issue a second indication message to tell at least one of the establishment time and the communication records of the comparison communication data (Step S180). As shown in FIG. 4, after the Step 180 is executed, the display module 16 of the electronic device 1 would automatically display the target to be verified on the display window A (i.e. the communication data and the communication feature data), and also automatically display the second indication message of the Step 180 on another display window C.

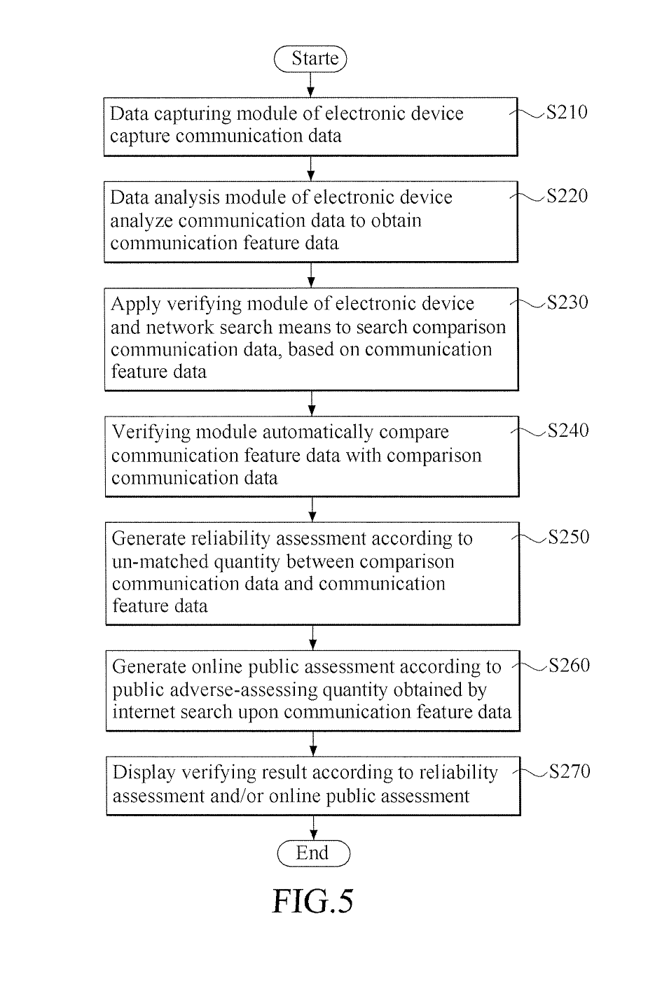

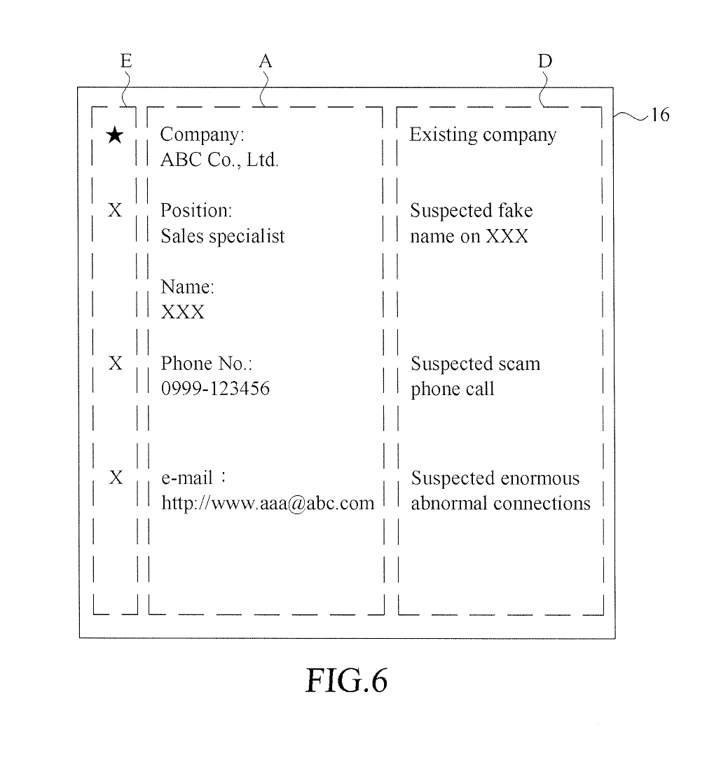

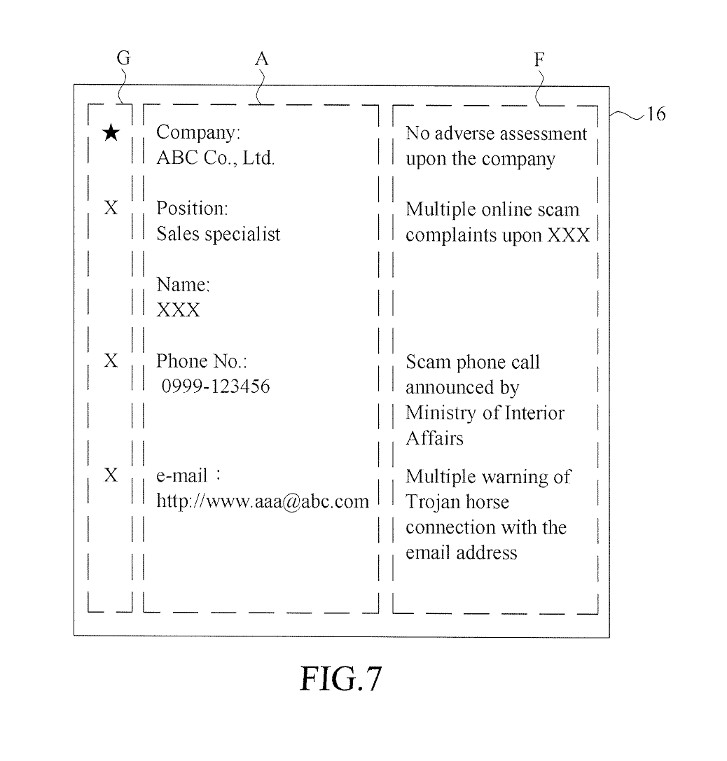

Refer now to FIG. 5 through FIG. 7, in which FIG. 5 shows a flowchart of a second embodiment of the method for exchanging data in accordance with the present invention, FIG. 6 demonstrates typically a portion of the display window of the display module of the second embodiment of FIG. 5, and FIG. 7 demonstrates typically another portion of the display window of the display module of the second embodiment of FIG. 5. In this second set of applications, the major purpose is to perform online far-end verification as follows.

Firstly, the electronic device 1 would drive the data capturing module 11 to apply a non-contact means to capture a communication data (Step 210). Details of the non-contact means herein are resembled to those for the aforesaid application in the first embodiment, and thus would be omitted herein.

After the step S210 has been executed, the data analysis module 12 of the electronic device 1 would automatically analyze the communication data to obtain at least one communication feature data (Step S220). In this second embodiment, details of the communication data and the communication feature data are resembled to those for the aforesaid application in the first embodiment, and thus would be omitted herein.

After the step S220 has been executed, the verifying module 13 of the electronic device 1 would automatically judge the communication feature data to search the comparison communication data through the network 5 (Step S230). In this second embodiment, details of the network 5 are resembled to those for the aforesaid application in the first embodiment, and thus would be omitted herein.

Then, the verifying module 13 of the electronic device 1 would automatically compare the communication feature data with the comparison communication data so as to generate a verifying result (Step S240). Thereafter, the verifying module 13 would base on the un-matched data quantity between the comparison communication data and the communication feature data to generate a reliability assessment symbolized by a reliability assessment symbol (Step S250).

In addition, the verifying module 13 of the electronic device 1 can also automatically base on a public adverse-assessing quantity of the communication feature data through the network search to generate an online public assessment symbolized by an online public assessment reliability assessment symbol (Step S260). Finally, the display module 16 would base on the reliability assessment and/or the online public assessment provided by the verifying module 13 to automatically display the verifying result (Step S270).

As shown in FIG. 6, after the Step 270 is executed, the display module 16 of the electronic device 1 would automatically display the target to be verified on the display window A (i.e. the communication data and the communication feature data), and also automatically display the reliability assessment of the Step S250 on another display window D. Alternatively, the reliability assessment symbol of the Step S250 can also be displayed automatically on another display window E, in which the reliability assessment symbol [symbol] ★ [symbol] stands for a situation that few or even no un-matched data quantity is found between the comparison communication data and the communication feature data. Namely, the associated credibility is high. On the other hand, if the reliability assessment symbol is an [symbol] x [symbol] , it implies that that a preset un-matched data quantity is found between the comparison communication data and the communication feature data. Namely, the associated credibility is low.

Alternatively, as shown in FIG. 7, after the Step 270 is executed, the display module 16 of the electronic device 1 would automatically display the target to be verified on the display window A (i.e. the communication data and the communication feature data), and also automatically display the online public assessment of the Step S260 on another display window F. Also, the online public assessment symbol of the Step S260 can also be displayed automatically on another display window G, in which the reliability assessment symbol [symbol] ★ [symbol] stands for a situation that few or even no public adverse-assessing quantity is found upon the communication feature data. Namely, the associated online public assessment is positive. On the other hand, if the online public assessment symbol is an [symbol] x [symbol] , it implies that that a preset public adverse-assessing quantity is found upon the communication feature data. Namely, the associated online public assessment is negative.

After the person with ordinary skill in the art reads the aforesaid disclosure, it shall be understood that, according to the aforesaid two applications of the related embodiments, six types of the verifying result are included: the first indication message, the second indication message, the reliability assessment, the reliability assessment symbol, the online public assessment and the online public assessment symbol. It is obvious to the art that any variations or derivatives from the aforesaid types of the verifying result shall also be within the scope of the present invention.

By compared to the conventional technique, the data-exchange technique for at least one electronic device to perform uni-directional or bi-directional capturing of the communication data in accordance with the present invention can simultaneously provide both near-end verification upon the address book data in the electronic device and far-end verification through a relevant network search means to automatically obtain corresponding verifying result on the captured communication data. Thus, the user can utilize the verifying result in a real-time manner to evaluate the credibility and the communication records of the communication data. It is no doubt that, by providing the technique for exchanging data in accordance with the present invention including the electronic device and the associating method, the situations of the scam, in-politeness, and embarrassment can be reduced to a minimum.

While the present invention has been particularly shown and described with reference to a preferred embodiment, it will be understood by those skilled in the art that various changes in form and detail may be without departing from the spirit and scope of the present invention.

What is claimed is:

1. A method for exchanging data, comprising the steps of:
(a) applying a data capturing module of an electronic device to capture a communication data;
(b) applying a data analysis module of the electronic device to analyze the communication data to obtain at least one communication feature data;
(c) applying a verifying module of the electronic device to capture at least one comparison communication data, and automatically comparing the communication feature data with the comparison communication data so as to generate a verifying result; and
(d) displaying the verifying result on a display module of the electronic device.

2. The method for exchanging data of claim 1, wherein the step (a) further includes one of the following steps:
(al) obtaining the communication data by capturing and analyzing an image of the communication data;
(a2) obtaining the communication data through a wireless transmission; and
(a3) obtaining the communication data by scanning and analyzing a barcode.

3. The method for exchanging data of claim 1, wherein the communication feature data includes at least one of a name of government facilities, a company name, an ID number of a company, a website of a company, an address of a company, a name of a correspondence, a telephone number and an email address.

4. The method for exchanging data of claim 1, wherein the comparison communication data is at least one address book data stored in the electronic device.

5. The method for exchanging data of claim 4, wherein the step (c) further includes a step (c1) of applying a network search means to search the communication feature data, thereby to generate a corresponding search result, and further to issue a first indication message for indicating the search result and inquiring a user of the electronic device whether or not to add the communication data into the address book data, if the verifying result is that the communication feature data and the address book data are totally unmatched.

6. The method for exchanging data of claim 4, wherein the step (c) further includes a step (c2) of issuing a second indication message for indicating at least one of an establishment time and a communication record of the comparison communication data, if the verifying result is that the communication feature data and at least one portion of the address book data are matched.

7. The method for exchanging data of claim 1, wherein the comparison communication data is searched by utilizing a network search means.

8. The method for exchanging data of claim 7, wherein the verifying result includes a reliability assessment of the communication data, in which the reliability assessment is generated by an unmatched data quantity between the comparison communication data and the communication feature data online searched by the network search means.

9. The method for exchanging data of claim 7, wherein the verifying result includes an online public assessment related to the communication feature data, in which the online public assessment is generated by applying the network search means to obtain a public adverse-assessing quantity related to the communication feature data, after comparing the communication feature data and the comparison communication data .

10. An electronic device, comprising:
a data capturing module, for capturing a communication data;
a data analysis module, coupled with the data capturing module, being to analyze the communication data to obtain at least one communication feature data ;
a verifying module, coupled with the data analysis module, being to capture at least one comparison communication data so as to automatically compare the communication feature data and the comparison communication data to generate accordingly a verifying result; and
a display module, coupled with the verifying module, being to display the verifying result.
